(19) United States
(12) Patent Application Publication
(10) Pub. No.: US 2009/0063627 A1
(43) Pub. Date: Mar. 5, 2009

(54) PLAYLIST ON DEMAND

(76) Inventor: David Nowacek, San Antonio, TX (US)

Correspondence Address: JACKSON WALKER, L.L.P., 112 E. PECAN, SUITE 2400, SAN ANTONIO, TX, 78205, US

(21) Appl. No.: 12/244,571

(22) Filed: Oct. 2, 2008

Related U.S. Application Data
(63) Continuation-in-part of application No. 12/295,831.
(60) Provisional application No. 60/928,810, filed on May 11, 2007.
(60) Provisional application No. 61/021,715, filed on Jan. 17, 2008.

(51) Int. Cl. G06F 15/16

(52) U.S. Cl. 709/203

(57) ABSTRACT

A playlist on demand is a type of product distribution network (PDN) that provides an easy method for users to access music heard on the radio or in other media. The user may sign up for an online service with a product distribution network (PDN) provider, which may include a customizable streaming playlist. When the user is listening to the radio, he or she may hear a song and want to add it to the playlist, but may not know the song's name, or may not be in a position to easily add that song through an online interface. In that case, the user can send a text message to the PDN provider, which may consist of the call letters or other identifier of a radio station the user is listening to. Alternative methods for sending a message to the PDN provider may include interactive features incorporated into the car stereo or into a standalone Radio Data System (RDS) receiver. When the PDN provider receives the message, it may then determine what song was playing on the station when the message was sent, and may then add the song to the user's playlist.

### CROSS REFERENCE TO RELATED APPLICATIONS

This application is a continuation-in-part and claims the benefit of U.S. application Ser. No. 12/295,831, entitled “Product Distribution Network,” filed Oct. 2, 2008, which is a U.S. national stage application of PCT application PCT/US08/63433, entitled “Product Distribution Network,” filed May 12, 2008, which claims the benefit of U.S. provisional application 60/928,810, entitled “A Method for Queuing and Retrieving Remote Content via Short Message Service,” filed May 11, 2007 and U.S. provisional application 61/021,715, entitled “Product Distribution Network,” filed Jan. 17, 2008. All of the above are incorporated herein by reference.

### BACKGROUND

This application relates to multimedia distribution, and more particularly to a device and method for creating on-demand playlists.

Even in an age of abundant online digital music services, radio is still a popular medium for listening to music, and is very effective at introducing people to new music. In particular, many people listen to radio while driving or at other times when it is not convenient or practical to find out the name of an unfamiliar song or artist, or to write down the information if they know it.

### BRIEF DESCRIPTION OF THE DRAWINGS

FIG. 1 is a network diagram of an embodiment of a service providing a playlist on demand;

FIG. 2 is a block diagram of an embodiment of a playlist server;

FIG. 3 is a front view of a mobile device displaying an embodiment of a confirmation screen that may be presented to a user in response to a request;

FIG. 3A is a front view of a mobile device displaying an embodiment of an information screen that may be presented to a user in response to a purchase of metadata;

FIG. 4 is a front view of a second embodiment of a confirmation screen that may be presented to a user in response to a request;

FIG. 5 is a front view of a car radio configured to request items for adding to a playlist;

FIG. 5A is a front view of the car radio of FIG. 5 displaying a response to a request;

FIG. 6 is a front view of a standalone Radio Data System (RDS) receiver configured to request items for adding to a playlist;

FIG. 6A is a front view of the standalone RDS receiver of FIG. 6 displaying a response to a request.

### SUMMARY OF THE INVENTION

In one aspect, a playlist on demand is a type of product distribution network (PDN) that provides an easy method for users to access music heard on the radio or in other media. The user may sign up for an online service with a product distribution network (PDN) provider, which may include a customizable streaming playlist. When the user is listening to the radio, he or she may hear a song and want to add it to the playlist, but may not know the song's name, or may not be in a position to easily add that song through an online interface. In that case, the user can send a text message to the PDN provider, which may consist of the call letters or other identifier of a radio station the user is listening to. Alternative methods for sending a message to the PDN provider may include interactive features incorporated into the car stereo or into a standalone Radio Data System (RDS) receiver. When the PDN provider receives the message, it may then determine what song was playing on the station when the message was sent, and may then add the song to the user's playlist.

### DETAILED DESCRIPTION OF THE EMBODIMENTS

A playlist on demand is a service that may be provided as an embodiment of a Product Distribution Network (PDN), such as that disclosed in co-pending PCT application PCT/US08/63433. Like some other embodiments of a PDN, the playlist on demand takes advantage of the fact that many listeners hear new music for the first time while listening to the radio. Recent research indicates that many people listen to the radio in cars, while in transit, or at other places outside the home where they do not have convenient access to their personal computers. This specification provides novel devices and methods for enabling users to learn what songs they are hearing on the radio, add them to an online playlist, and order them easily and with minimal distraction.

One reason to provide an online playlist is the possibility of generating revenue with advertisements. In some embodiments, a PDN may be wholly supported by ad revenue, while in others, ad revenue may supplement revenue streams from direct sales. In one embodiment, a user listening to the radio may hear a song he or she likes and wants to have access to later. The user operates a wireless communication device, such as a mobile phone, to send a short message, such as an SMS text message, to the PDN provider. The content of the message is call letters, frequency, an alias, trade name, or other information identifying the radio station the user is listening to. Based on the information, the PDN may query a metadata provider to determine what song is playing on the radio station. The PDN may then send a message back to the user with options such as adding the song to a playlist, purchasing metadata, or purchasing the song as a digital download.

When the user later accesses a personal computer or other network-enabled device, he or she can visit a website operated by the PDN. The website may provide a media player that plays selections from the user's playlist in a random or specified order. It may also provide other value-added options such as lyrics, information about the artists, and links to sites where the user can download the songs as digital files. The website may generate or supplement revenue by prominently placing paid advertisements. In other embodiments, the PDN provider may provide a standalone software player that the user can run from a personal computer. The standalone player may retrieve songs from the playlist as streaming media, and may likewise display advertisements and value-added content.

Whether the media player is web-based or standalone, persons of ordinary skill in the art will recognize several models for implementing a playlist on demand. By way of non-limiting example, a select number of radio stations may use a playlist on demand to increase listener loyalty. This would allow users to enjoy a streaming, personalized version of the radio station that plays little or no music the user does not personally enjoy. Besides promoting loyalty, this model can also help to drive users to the radio station's website. In other embodiments, the playlist could be unaffiliated with a particular radio station, but the user may be able to categorize music, for example by genre or style. The stream may be interspersed with some tracks that the user has not pre-selected, so that she is still introduced to new music. The tracks may be selected by a recommendation engine that predicts which songs the user is likely to enjoy, and she may be able to respond by marking a recommendation acceptable or not acceptable. In some embodiments, the user may be able to create or join a network of friends, all of which may be permitted to add songs to a master playlist, thus diversifying the available music. The user may receive a copy of this master playlist, and further refine it for her own tastes by voting on her preferences for songs. And in addition to advertising displayed with the media player itself, more traditional commercials may be interspersed throughout the stream. With traditional radio stations, many users will change channels to avoid commercials. But in this case, the user may be more likely to listen through the commercial because she will be more confident that the commercial will be followed by a song she enjoys hearing.

Although previous examples disclose a mobile phone or PDA, other wireless devices may also be provided for interacting with the PDN. Some of these particularly address the concern that it is not generally safe for users to send text messages while driving. For example, a radio may be configured for use with the PDN, and may provide a single, prominent button that initiates communication with the PDN. Other buttons, such as those that are normally used for radio “pre-sets,” may then be used to complete the transaction. Another possible device is a standalone RDS receiver. This receiver may display partial metadata about the song based on the RDS stream and provide buttons that similarly allow a user to easily select desired songs.

A playlist on demand will now be described with more particular reference to the attached drawings. Hereafter, details are set forth by way of example to facilitate discussion of the disclosed subject matter. It should be apparent to a person of ordinary skill in the art, however, that the disclosed embodiments are exemplary and not exhaustive of all possible embodiments. Throughout this disclosure, a hyphenated form of a reference numeral refers to a specific instance or example of an element and the un-hyphenated form of the reference numeral refers to the element generically or collectively. Thus, for example, 102-1 may refer to a “pen,” which may be an instance or example of the class of “writing implements.” Writing implements may be referred to collectively as “writing implements 102” and any one may be referred to generically as a “writing implement 102.”

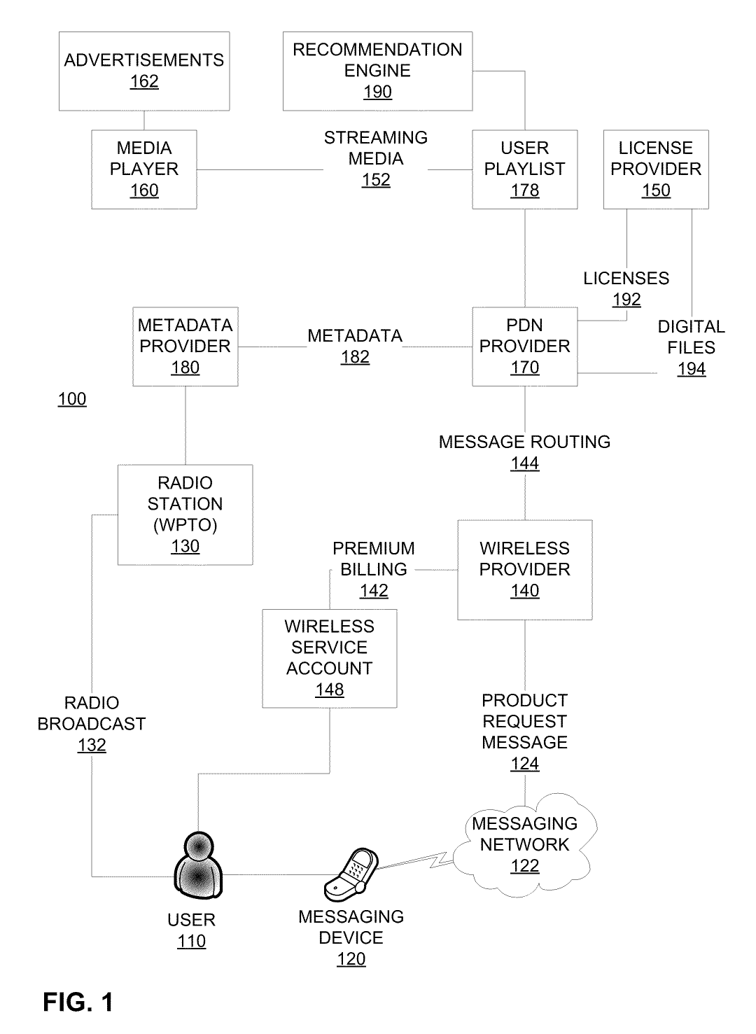

FIG. 1 is a network diagram disclosing an embodiment of a PDN 100 providing a playlist on demand service. In this embodiment, user 110 is listening to radio broadcast 132, provided by radio station 130. User 110 hears a song on radio station 130 and wants to add the song to her playlist. User 110 operates messaging device 120 to send a product request message 124 through messaging network 122, to wireless provider 140. User 110 has a wireless service account 148, with wireless provider 140. Wireless provider 140 may apply premium billing 142 to user 110's wireless service account 148. Product request message 124 is then sent through message routing 144 to PDN provider 170. In some embodiments, product request message 124 includes a time stamp and textual information identifying radio station 130. PDN provider 170 queries metadata provider 180 and receives metadata 182 identifying the song that radio station 130 was playing when user 110 sent product request message 124. PDN provider 170 then adds the requested song to user playlist 178, which is accessible by user 110. PDN provider 170 also interfaces with license provider 150 to receive licenses 192 and digital files 194. The digital files 194 are used to create streaming media 152. When user 110 wants to hear songs in her playlist, she may operate media player 160, which is provided with streaming media 152 from user playlist 178 provided by PDN provider 170. PDN provider 170 may also cause advertisements 162 to be sent to media player 160. In some embodiments, a recommendation engine 190 is also provided. Recommendation engine 190 may provide recommended additions to user playlist 178 based on user preferences, listening habits, preferences of similar users, or profiles of media. Recommendation engine 190 may thus be used to introduce user 110 to other new music. As disclosed, network 100 allows user 110 to easily add new songs to her playlist 178 even if she does not know the name of the song or who performs it.

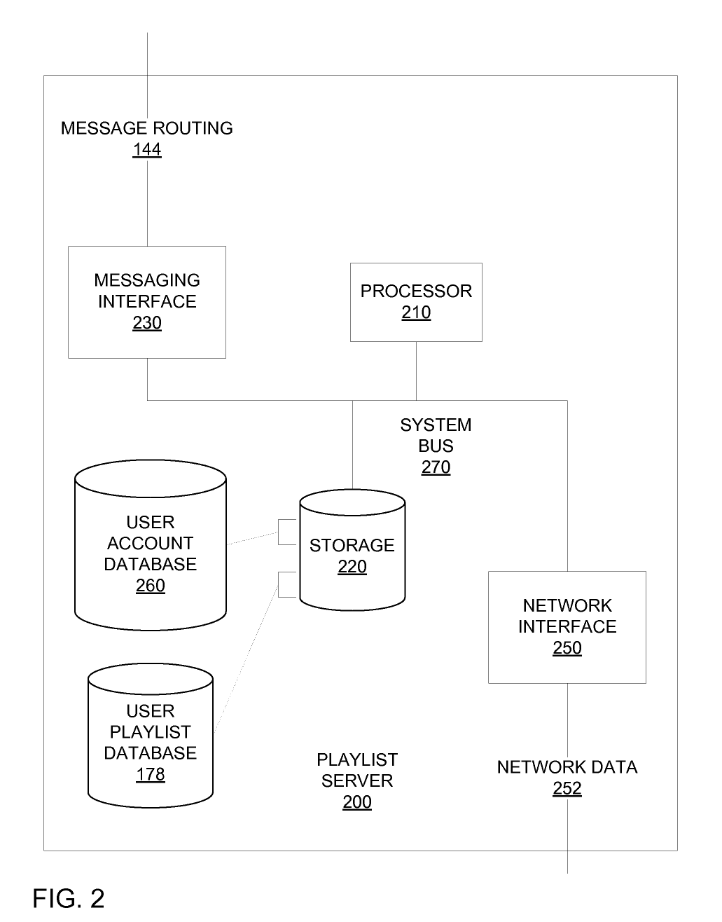

FIG. 2 is a block diagram of a playlist server 200 that may be operated by PDN provider 170. In this embodiment, a processor 210 is connected to other parts of the system through a system bus 270. Included in the system is a messaging interface 230 that connects playlist 200 to message routing 144. This allows playlist server 200 to send and receive messages through wireless provider 140 (FIG. 1). Playlist server 200 also includes a storage medium 220, which may be populated with a user account database 260, and a user playlist database 178. In this case, each user account in the user account database 260 will be associated with one or more user playlist 178. Playlist server 200 is then connected to network services through network interface 250 which handles network data 252. In some embodiments, messaging interface 230 and network interface 250 may be a single physical device.

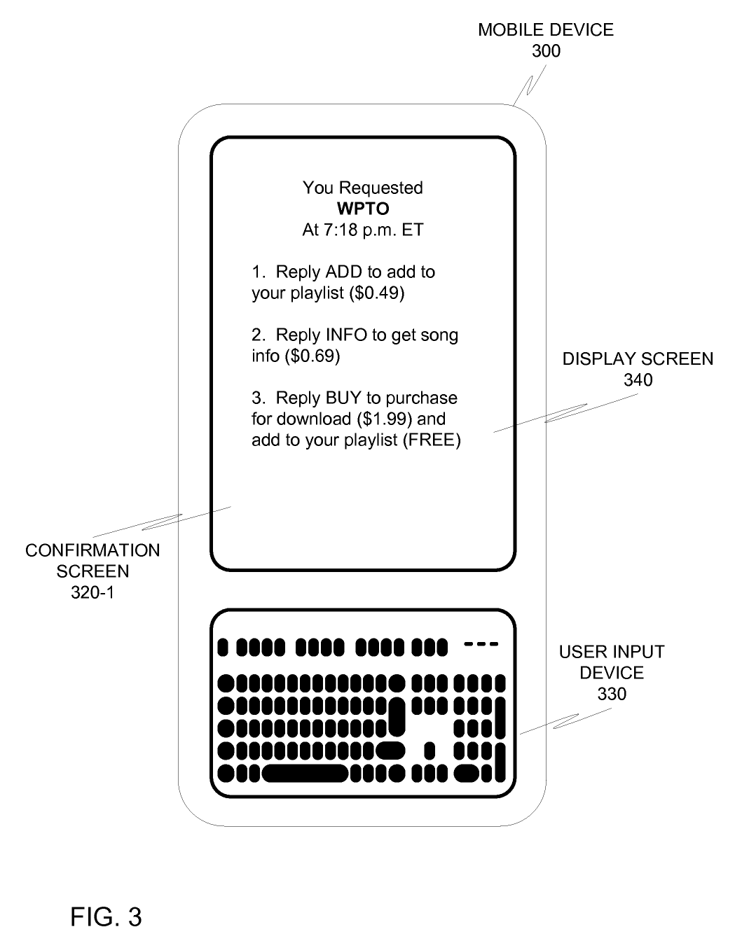

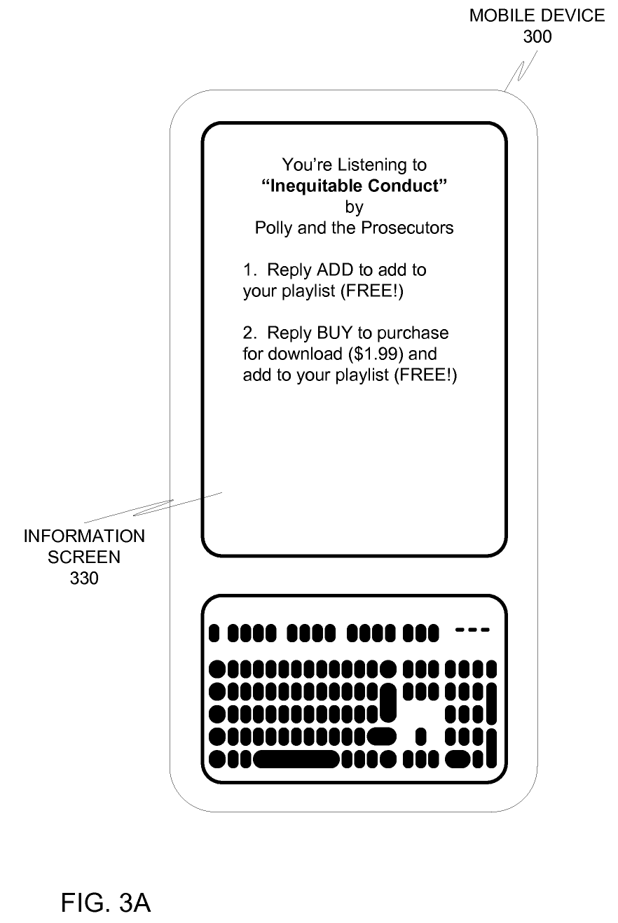

FIG. 3 is a front view of an embodiment of a mobile device 300 for use with a PDN 100 (FIG. 1) providing a playlist on demand. Mobile device 300 may include a user input device 330 and a display screen 340. In this exemplary embodiment, the user has heard a song on radio station WPTO at 7:18 pm EST and has sent a text message with the text code “WPTO”. Confirmation screen 320-1 is a text message, which gives the user three confirmation options. First, the user may reply with the text “ADD” to add the song to his playlist. In some embodiments, this option may carry a charge, for example $0.49. Second, the user 110 may reply “INFO” to order metadata related to the song that he heard. In some embodiments, this option may carry a separate charge, for example, $0.69. Third, the user may reply “BUY” to purchase the song for download and add to his playlist. In some embodiments, the purchase may carry a charge, but the song may be added to the playlist for no additional charge. For example, in this embodiment, the user is charged $1.99 to purchase the song for download, but is not charged any additional amount to add this song to his playlist.

FIG. 3A discloses the mobile device 300 of FIG. 3. In the embodiment shown, the user has selected option 2 to purchase the metadata. In this case, the user has additional options. The user may reply “ADD” to add the song to his playlist, which in some embodiments will not carry an additional charge. Second, the user may have another opportunity to purchase the song for download by responding “BUY,” and also may add the song to his playlist for no additional charge. Whether and how much to charge for each of these steps will depend on the business model. It will be within the skills of the person of ordinary skill in the art to select an appropriate business model for generating the desired revenue.

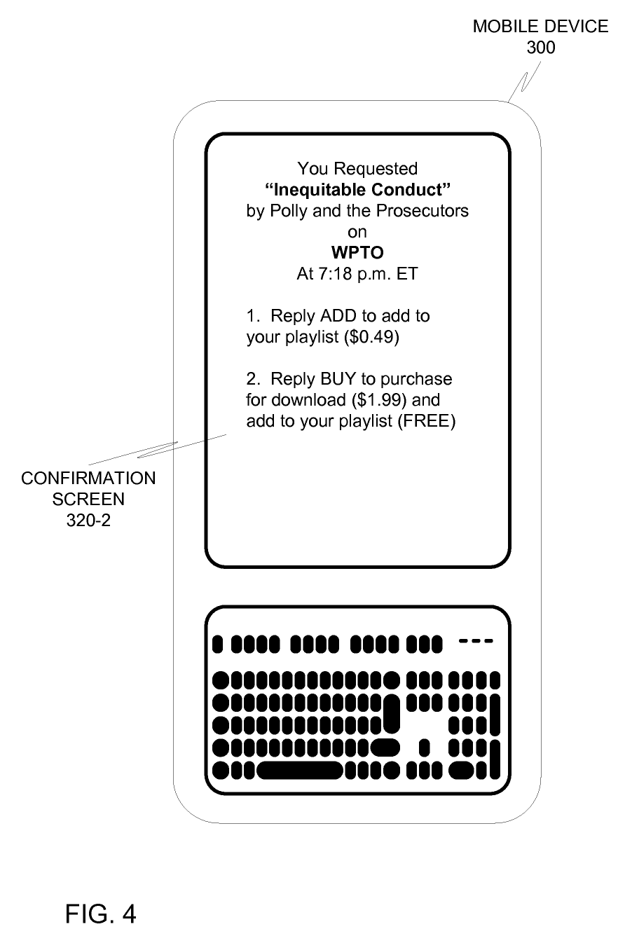

FIG. 4 discloses an embodiment of a mobile device 300 wherein confirmation screen 320-2 displays the options that are associated with a slightly different business model. In this case, at least partial metadata are automatically provided to the user in response to the first request. For example, the response message tells the user that she is listening to the song “Inequitable Conduct” by Polly and the Prosecutors. She may then reply “ADD” to add the song to her playlist for a charge, for example, $0.49. The user may also reply “BUY” to purchase the song for download, and also to add to her playlist, possibly for no additional charge. These embodiments anticipates a case where the sale of metadata is not intended to be a primary revenue stream. In some embodiments, the option to add to the playlist will also be free. In those cases, it may be that the primary source of revenue is advertising revenue and the on-demand playlist is intended primarily to drive traffic to media player 160 (FIG. 1) so that advertisements 162 (FIG. 2) can be displayed to the user.

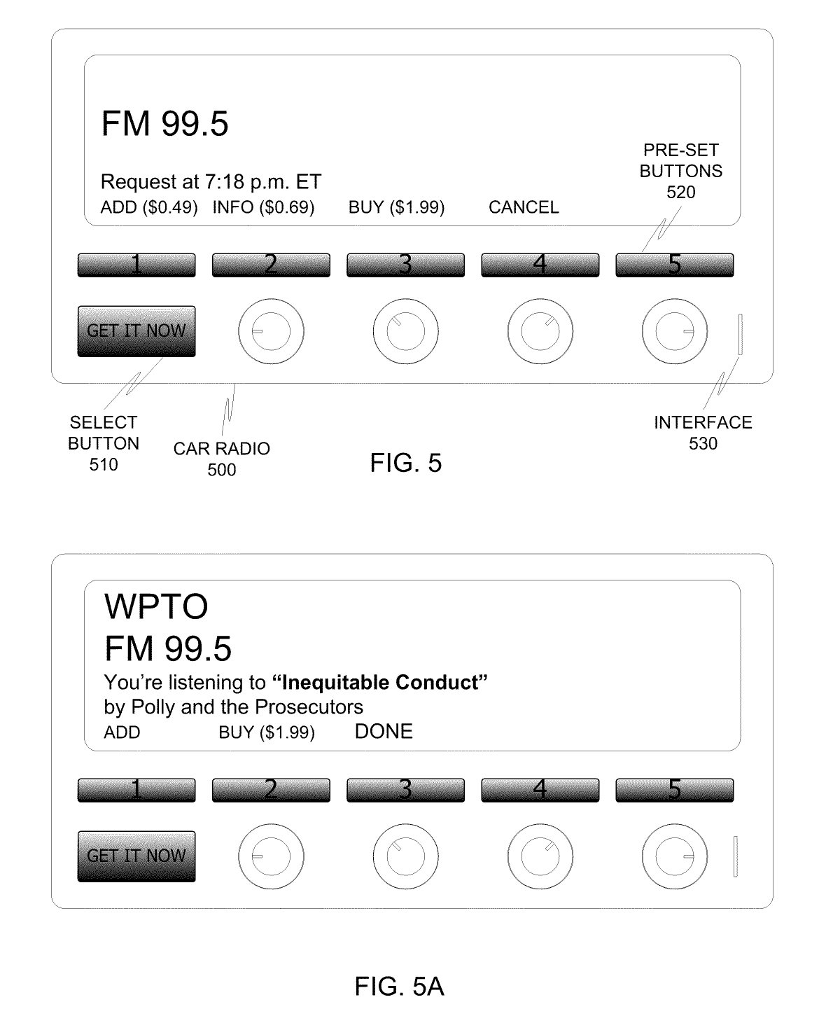

FIG. 5 is a front view of a radio, which may be a car radio, configured for use with a PDN 100 (FIG. 1). This embodiment addresses the issue that it is not generally safe for users to send text messages while driving a car. In this case, car radio 500 is provided with a select button 510 which allows the user to easily select the songs that he hears on the radio. Car radio 500 may be provided with wireless capabilities analogous to those of a mobile telephone. In some embodiments, a user may be required to sign up for a separate wireless service, which may be a minimal service providing only text services for use with a PDN. In another embodiment, car radio 500 may be provided with the ability to imitate the user's cell phone for short periods while completing a network transaction. For example, interface 530 may be provided for the user to insert a SIM card from his cell phone. Car radio 500 may read data from the SIM card and store them internally so that the car radio 500 is then able to operate as though it were the user's cell phone. In that case, if the user hears a song he would like to add to his playlist, he may push the select button 510. In response, the user would be provided with options, for example, he may use the preset buttons 520, which are normally used to select a pre-set radio station, as an interface for the network. In this case, the user may press button 1 to add the song to his playlist for $0.49, he may press 2 to retrieve the song's metadata for $0.69, he may press 3 to buy the song for $1.99, or he may press 4 to cancel the transaction.

As shown in FIG. 5A if the user presses button 2, additional information about the song now playing may be displayed. For example, the call letters of the radio station may be filled in. In this case, they are WPTO. The display may also show the user that he is listening to “Inequitable Conduct” by Polly and the Prosecutors. The preset buttons may now provide additional options. For example, the user may press 1 to add the song to his playlist for no additional charge, or he may press 2 to purchase the song for download for $1.99. If the user does not want to take anymore action, he may press 3 to signify that he is done, and the radio will then return to its normal state. Some embodiments of a car radio 500 may be configured for use with RDS data. In that case, the information such as the radio station call letters and the name and artist of the song may already be displayed. So the option to purchase metadata may be superfluous. Other options may then be displayed in response to the user using the select button 510. For example, he may add the song to his playlist by pressing 1, possibly for free, or buy the song for $1.99 by pressing 2.

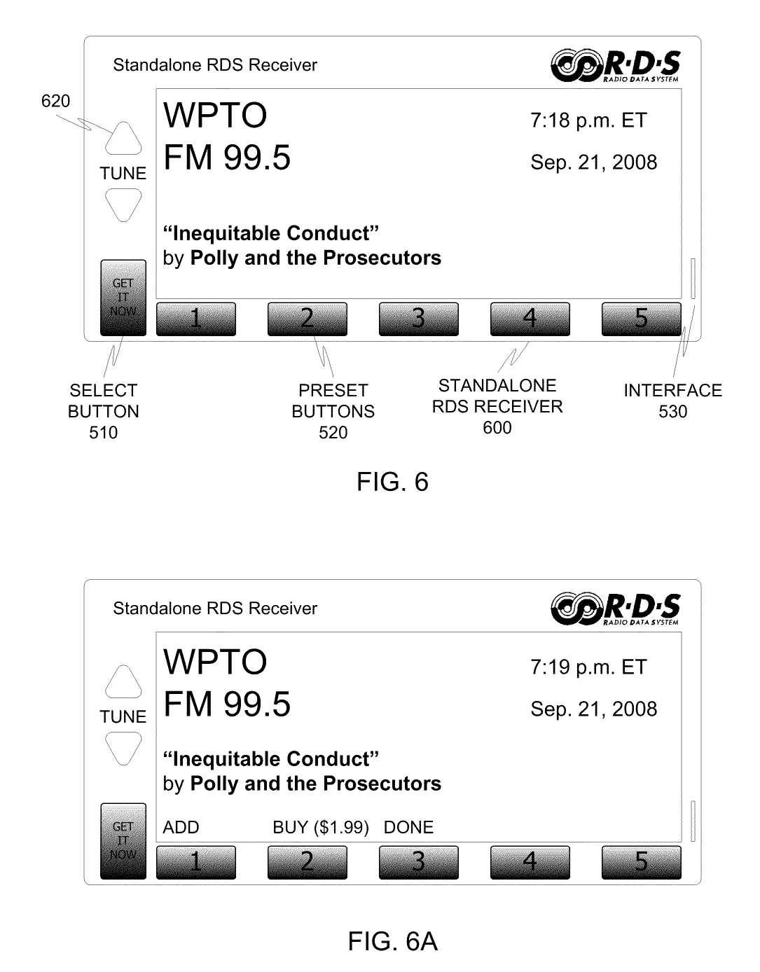

FIG. 6 discloses an embodiment of an RDS receiver 600 that may be used instead of installing a completely new radio system. RDS receiver 600 may be a simple device with a display screen that is powered either by batteries or through the car's cigarette lighter, and may include an antenna useful for both receiving one-way radio signals and two-way wireless communication. RDS receiver 600 may include a simple tuning interface such as tuning buttons 620. Tuning buttons 620 allows the user to select a radio station and RDS receiver 600 may then display the RDS data associated with that station. A number of preset buttons may also be provided to store favorite stations. In some cases, a user may program preset buttons 520 with the same radio stations that are programmed on her radio's preset buttons. In that case, when she is listening to radio station WPTO at a frequency of 99.5 MHz, which is programmed in preset button 1 on her radio, she may also select preset button 1 on her RDS receiver 600. RDS receiver 600 will then display the appropriate metadata as received. In some embodiments, this may include the call letters of the radio station, the name and artist of the currently playing song, and additional information such as the date and time. In this embodiment of an RDS receiver 600, a select button 510 is provided. When the user hears a song on car radio 500 that she wants to select, she may operate the select button 510. She will then be presented with options. For example, by pressing preset button 1 she may add the song to her playlist. By pressing preset button 2, she may buy the song for $1.99. In some embodiments, if she only wants to add the song to her playlist, there will be no charge. This embodiment anticipates a revenue stream based primarily on advertisement. Similar to car radio 500, RDS receiver 600 may be provided with an interface 530 that allows the RDS receiver 600 to interface with the user's mobile phone, either by being programmed through the SIM card or communicating through a cable or wirelessly. In this manner, RDS receiver 600 may also act as a messaging device 120, for the limited purpose of operating with the PDN 100 (FIG. 1).

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A method of providing a playlist on demand, the method comprising the steps of:
receiving a product request message from a user, the product request message including a time stamp and textual information;
correlating the time stamp with the textual information to uniquely identify a song;
sending a response message to the user, the response message containing instructions for a confirmation message;
receiving from the user a confirmation message; and
in response to the confirmation message, adding the song to a playlist accessible by the user.
